(19) United States
(12) Patent Application Publication
(10) Pub. No.: US 2017/0260959 A1
(43) Pub. Date: Sep. 14, 2017

(54) HYDRAULIC TURBOMACHINE

(71) Applicant: VOITH PATENT GMBH, HEIDENHEIM (DE)

(72) Inventors: THOMAS POPELKA, MELK (AT); MARTIN SCHABASSER, PFAFFING (AT)

(21) Appl. No.: 15/610,800

(22) Filed: Jun. 1, 2017

Related U.S. Application Data
(63) Continuation of application No. PCT/EP2015/075210, filed on Oct. 30, 2015.

(30) Foreign Application Priority Data
Dec. 1, 2014 (DE) 10 2014 224 480.3

(51) Int. Cl. F03B 3/18; F15B 11/18; F03B 3/06

(52) U.S. Cl. CPC F03B 3/183; F03B 3/06; F15B 11/183; F05B 2260/406; F05B 2260/70

(57) ABSTRACT

A hydraulic turbo machine has a runner that is impinged by water. A diffuser has a multiplicity of guide blades. The diffuser includes a regulating ring for rotating the guide blades. At least one hydraulic servomotor is connected to the regulating ring or to the runner blades. The servomotor has a multiple stage configuration. The housings of the stages are fixedly connected to one another and the pistons of the stages interact only in a part range of the entire adjusting range of the servomotor.

### CROSS-REFERENCE TO RELATED APPLICATION

This application is a continuation, under 35 U.S.C. §120, of copending international application No. PCT/EP2015/075210, filed Oct. 30, 2015, which designated the United States; this application also claims the priority, under 35 U.S.C. §119, of German patent application No. 10 2014 224 480.3, filed Dec. 1, 2014; the prior applications are herewith incorporated by reference in their entirety.

### BACKGROUND OF THE INVENTION

### Field of the Invention

The invention relates to a hydraulic turbomachine, in particular a water turbine, pump turbine or pump. The hydraulic turbo machine has a runner which is loaded by water, a diffuser with a multiplicity of guide blades, which diffuser comprises a regulating ring for rotating the guide blades, and at least one hydraulic servomotor. The hydraulic turbomachine may be a Francis type turbine or a Kaplan type turbine, or another machine. It is primarily important that they are machines having a diffuser.

Reference is had, with regard to the basic concept of such turbomachines, to U.S. Pat. No. 1,706,372.

The diffuser of a turbo machine of this type comprises a multiplicity of guide blades which enclose the runner. The individual guide blades are mounted rotatably and can be pivoted in each case about an axis which runs parallel to the runner axis. In this way, the water through flow through the hydraulic turbo machine can be regulated. Here, the guide blades are fastened to a regulating ring by means of levers and links. The regulating ring is mounted such that it can be rotated concentrically with respect to the runner axis. When the regulating ring is rotated, the guide blades are rotated about its respective rotational axis. The rotation of the regulating ring is brought about by way of at least one hydraulic servomotor which is fastened between the regulating ring and a fixed housing part in such a way that the regulating ring is rotated when the piston of the servomotor is moved.

Since considerable forces have to be applied for the movement, depending on the operating state, the hydraulic servomotors are as a rule very large and therefore also expensive. Moreover, mineral oil is as a rule used as hydraulic liquid. A not inconsiderable quantity of hydraulic oil is required for the operation on account of the size of the servomotors. Said oil can lead to environmental pollution in the case of a fault.

### BRIEF SUMMARY OF THE INVENTION

It is accordingly an object of the invention to provide a hydraulic turbomachine which overcomes the above-mentioned and other disadvantages of the heretofore-known devices and methods of this general type and which provides for a hydraulic turbomachine of the type mentioned above in which the production costs are reduced and the environmental risk as a result of an unintentional oil discharge is reduced.

With the foregoing and other objects in view there is provided, in accordance with the invention, a hydraulic turbo machine, comprising:

a runner to be impinged by water;

a diffuser formed with a multiplicity of guide blades, said diffuser having a regulating ring for rotating said guide blades; and

at least one hydraulic servomotor connected to said regulating ring, said hydraulic servomotor having a multi-stage configuration with a plurality of stages, each stage having a housing and a piston, said housings of said stages being fixedly connected to one another, and said pistons of said plurality of stages interacting only in a part range of an entire adjusting range of said hydraulic servomotor.

In other words, the objects of the invention are achieved by virtue of the fact that, by way of the apparatus according to the invention, firstly the servomotor can be of smaller configuration and secondly the required oil quantity is reduced, as a result of which the environmental risk is reduced in the case of damage and accidental spillage. The costs for the oil system (for example, in the case of the piston accumulator and/or air vessel) are also reduced proportionally to the required oil quantity.

The inventors have recognized that the size of the servomotors which are used for adjusting the regulating ring is determined by the maximum torque which occurs on the guide blade. Said torque determines the diameter and/or the piston area of the servomotors. The piston area of the servomotors has to be so great that they can apply the torque in the case of a given minimum pressure of the hydraulic liquid. They have further recognized that said maximum torque occurs only at an end of the adjusting travel of the regulating ring.

Other features which are considered as characteristic for the invention are set forth in the appended claims.

Although the invention is illustrated and described herein as embodied in a hydraulic turbomachine, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 shows a hydraulic servomotor for rotating a regulating ring of a hydraulic machine in accordance with the prior art;

FIG. 2 shows the hydraulic servomotor according to the invention for rotating a regulating ring of a hydraulic machine in the first end position;

FIG. 3 shows the hydraulic servomotor according to the invention for rotating a regulating ring of a hydraulic machine in a middle position;

FIG. 4 shows the hydraulic servomotor according to the invention for rotating a regulating ring of a hydraulic machine in the second end position;

FIG. 5 shows the hydraulic servomotor according to the invention in a further embodiment;

FIG. 6 is a highly diagrammatic view of a hydromachine of the Francis type with a rotor wheel;

FIG. 7 is a diagrammatic plan view onto a portion of a diffuser; and

FIG. 8 is a diagrammatic view of a rotor wheel for hydraulic turbomachine of the Kaplan type.

### DETAILED DESCRIPTION OF THE INVENTION

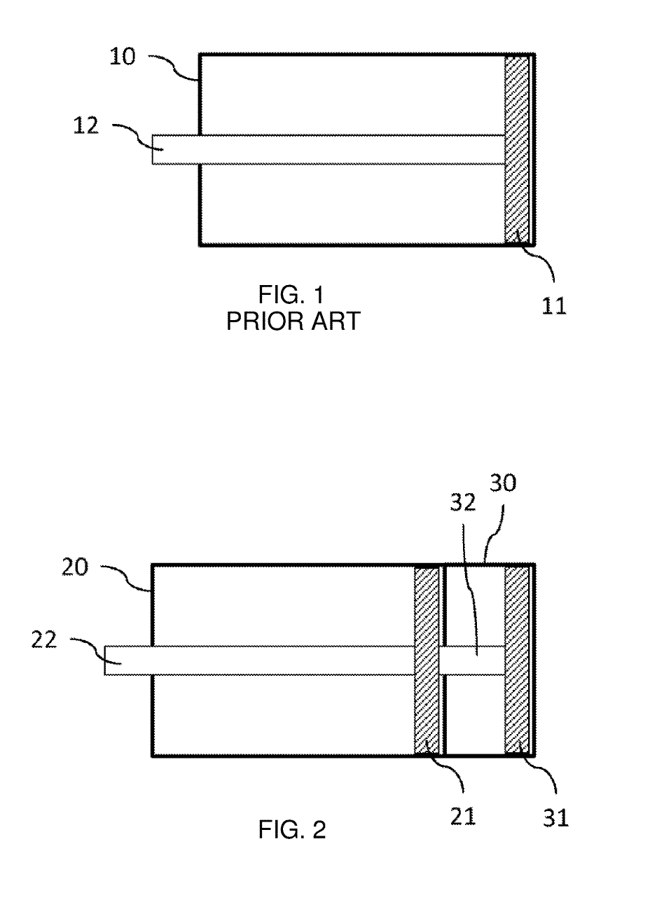

FIG. 1 shows a section through a servomotor, as is situated in a hydraulic machine in accordance with the prior art. The servomotor has a cylindrical housing 10, in which a piston 11 with a rod 12 which is connected to the piston 11 in a positively locking manner is situated. Here, the piston 11 and the rod 12 are attached in a freely displaceable manner within the housing 10. The piston 11 terminates circumferentially with the housing in a sealing manner, with the result that two chambers are produced within the housing, which chambers can be filled in each case with pressurized hydraulic liquid. In a known way, the piston 11 with the rod 12 can be moved to and fro with the aid of the hydraulic liquid.

Here, within the hydraulic machine, the servomotor is attached between the regulating ring and the fixed housing of the machine in such a way that the regulating ring can be rotated by way of a displacement of the piston 11. This is not shown in FIG. 1, however.

At a given maximum pressure of the hydraulic liquid which is used, the maximum torque which can be transmitted from the servomotor to the regulating ring is proportional to the area of the piston 11, with the result that, as has already been described, the cylindrical housing of the servomotor has to be dimensioned in accordance with the maximum required torque. The volume of the servomotor and therefore also the quantity of the required hydraulic oil then also become correspondingly great.

The inventive concept then consists in the servomotor being of multiple stage configuration in a particularly expedient way, only one stage of the servomotor being used for the operating range, in which only a low torque is required, and the further stages being added successively in the operating ranges which require a higher torque. The configuration of the further stages is fundamentally independent of the main stage, that is to say the operating pressure and diameter are not linked to the main stage.

The case where the entire operating range splits only into two part ranges is particularly simple. According to experience, this is the normal case in many hydraulic machines. There is usually a large range which requires only a comparatively low torque and a smaller range, in which a torque which is up to twice as high is required. Here, the terms “large” and “small” in the preceding sentence relate to the adjustment travels of the servomotor which are to be overcome in said ranges.

For the case which is mentioned in the last paragraph, the servomotor according to the invention is of two stage construction. One possible embodiment is shown in FIG. 2 in section. The servomotor according to the invention has two housing parts 20 and 30 which are connected to one another and comprise in each case one piston (21 and 31) and in each case one rod (22 and 32) which is connected to the respective piston in a positively locking manner. Here, the left-hand housing 20 is substantially longer than the right-hand housing 30. As will still be described further below, the housing length corresponds to the adjusting travels of different magnitude in the two operating part ranges. The servomotor according to the invention which is shown in FIG. 2 is situated in a position, in which the rod 22 which protrudes out of the entire housing is retracted as far as possible, which corresponds to the one end of the operating range. If the two chambers of the part housings 20 and 30 which lie in each case to the right of the pistons 21 and 31 are then filled with hydraulic liquid which is under a suitable pressure, the pistons 21 and 31 will move in each case to the left and the rod 22 will move out of the entire housing. Here, the pistons 21 and 31 interact, that is to say the forces which are applied by the two said pistons are added, and the torque which is transmitted to the regulating ring is correspondingly high. The maximum torque which can be applied in this way is proportional to the sum of the hydraulically active area of the pistons 21 and 31.

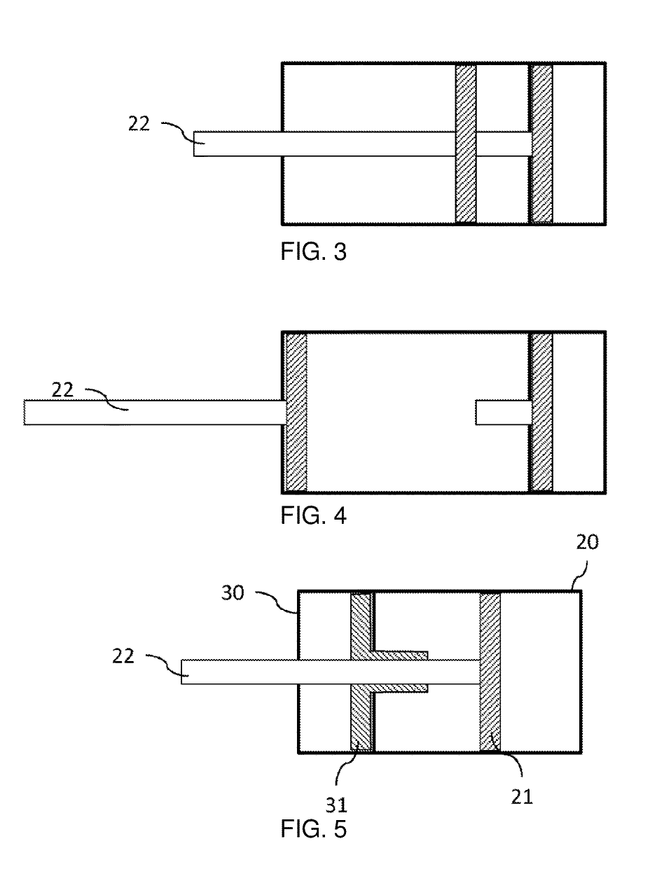

FIG. 3 shows the servomotor according to the invention from FIG. 2 in another position. The parts are the same as in FIG. 2 and the designations have been omitted for the sake of clarity. The servomotor stage which consists of the housing part 30, the piston 31 and the rod 32 is completely extended, that is to say the piston 31 is now situated completely on the left-hand side of the part housing 30. The pistons 21 and 31 interact in the states which lie between the states which are shown in FIGS. 2 and 3. If the rod 22 is to be moved even further to the left as shown in FIG. 3, this can take place only if the piston 21 is pushed further to the left independently of the piston 31. This is only possible if there is no positively locking connection between the piston 21 and the rod 32. The piston 21 and the rod 32 are therefore in a non-positive connection in FIGS. 2 and 3 and all states which lie in between. It is clear that the interaction of the two servomotor stages comes about in this way only in one direction, to be precise, in the case which is shown in FIGS. 2 and 3, only when the rod 22 is pushed out of the entire housing. Here, the pressures of the hydraulic liquid in the part housings 20 and 30 have to be selected correspondingly such that the piston 21 and the rod 32 are permanently situated in a non-positive connection, which can be fulfilled simply as long as the pressure to the right of the piston 31 is greater than that to the left thereof. The fact that the interaction of the pistons 21 and 31 acts only in one direction does not represent a problem, however, during operation of a hydraulic machine according to the invention, since the maximum torque has to be transmitted only in one direction. For the movement in the other direction, the force from the area to the left of the piston 21 is sufficient, with the result that an additional force of the piston 31 is not required.

FIG. 4 shows the same servomotor according to the invention in a position, in which the rod 22 is extended as far as possible out of the entire housing, which corresponds to the other end of the operating range (in relation to the state which is described in FIG. 2). The piston 21 is then separated from the rod 32. In all states which lie between the states from FIG. 3 and FIG. 4, the piston 21 is separated from the rod 32. Therefore, the piston 21 acts independently of the piston 31 in said states. The transmitted torque is therefore only still proportional to the area of the piston 21 alone.

It should be noted, in respect of the embodiment which is shown in FIGS. 2 to 4, that the adjusting travels which are passed through in the two operating ranges are of different magnitude, since the servomotor stages are of different length. The operating range, in which the two stages interact (between FIG. 2 and FIG. 3), has a much smaller adjusting travel range to be passed through, compared with the operating range, in which only the left-hand servomotor stage acts alone (between FIG. 3 and FIG. 4). This corresponds to the condition which prevails in most hydraulic machines, namely that the high torque is required only over a relatively small adjusting travel range. Cases are also conceivable, however, in which the two ranges (a range, in which both stages interact, and a range, in which only one acts alone) require proportions of approximately identical magnitude of the entire adjusting travel, or that there is even the reverse ratio (that is to say, the range of the interaction comprises a greater proportion of the adjusting travel than the range, in which only one acts alone). The lengths of the servomotor stages then have to be selected accordingly. If the two servomotors in the example which is shown (FIGS. 2 to 4) both had the same length, the two stages would interact over the entire adjusting travel range. Therefore, a stage which is to be active only over a limited adjusting travel range is always shorter than the stage which acts over the entire adjusting travel range or over a greater adjusting travel range. Here, the length of the shorter stage determines the length of the adjusting travel, over which the two stages interact.

It also becomes clear from what has been said that the servomotor according to the invention, starting from the maximum required torque which has to be transmitted, requires only a considerably smaller diameter. Since the areas of the two pistons 21 and 31 interact, the diameter can be reduced in comparison with the prior art almost by the factor 1/√2 (during interaction, the hydraulically active area of the piston 21 around the cross-sectional area of the rod 32 is smaller than the hydraulically active area of the piston 31; therefore the factor is not quite 1/√2). The quantity of required hydraulic oil is also considerably lower than in the prior art, since the interaction of the two servomotor stages extends only over part of the adjusting travel.

FIG. 5 shows another possible embodiment of the servomotor according to the invention. Here, the two servomotor stages are swapped in terms of location. Said embodiment is expedient when the maximum torque to be transmitted occurs on the other side of the operating range. In the case of FIGS. 2 to 4, the maximum torque occurs when the rod 22 is completely retracted. The two pistons interact there when the rod 22 is extended starting from said state. In the case of FIG. 5, the maximum torque occurs when the rod 22 is completely extended. Here, the two pistons interact when the rod 22 is retracted starting from said state. There is a non-positive connection of the two pistons only then. The analog to the rod 32 from FIG. 2 is formed in FIG. 5 by way of the tubular protrusion of the piston 31 which encloses the rod 22. The state which is shown in FIG. 5 corresponds to a state, in which only the piston 21 acts.

Servomotors according to the invention with more than two stages are likewise conceivable and can further increase the abovementioned improvements. In most cases, however, a satisfactory improvement will already be achieved by way of a two stage embodiment.

Moreover, it is likewise conceivable to combine the two embodiments (that is to say, that shown in FIGS. 2 to 4 with that from FIG. 5) in such a way that in each case one servomotor stage which is active only in a part range is attached both to the right and to the left of the permanently active servomotor stage.

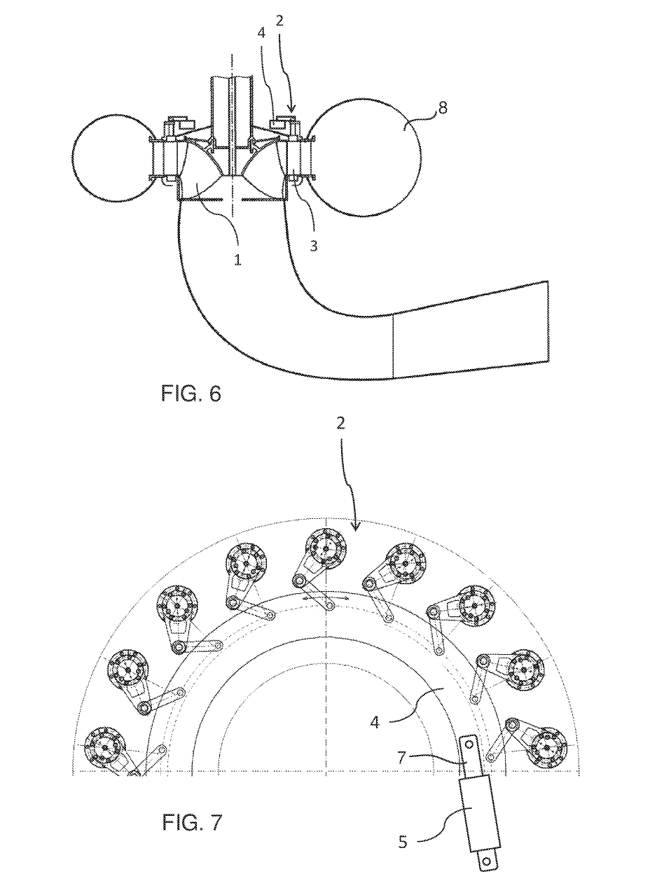

FIG. 6 is an illustration of a hydraulic turbomachine with a runner of the Francis type. A runner or rotor 1 is rotatably supported about a central axis inside a spiral casing 8, which is illustrated in cross-section. A diffuser 2 carries a plurality of guide vanes 3. A regulating ring 4 is configured for rotating the guide vanes 3.

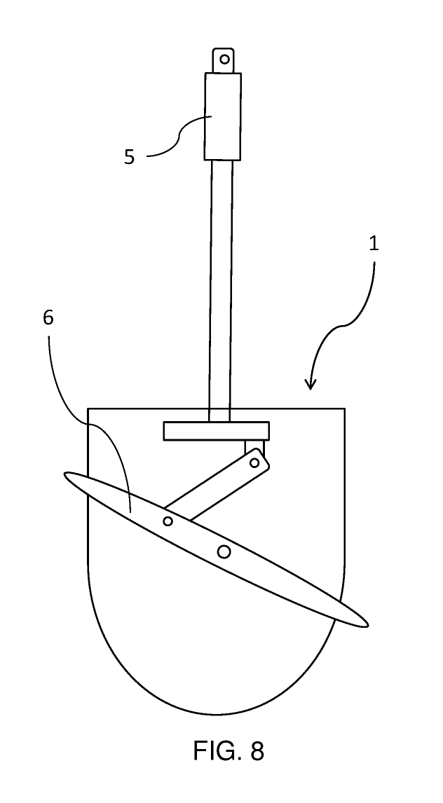

FIG. 7 shows a partial plan view of a diffuser 2. The regulating ring 4 is rotated about the central axis by way of a servomotor 5, which connects to the regulating ring by way of a regulating rod 7. The servomotor 5 is formed in accordance with any of the embodiments of the invention, as described above.

FIG. 8 is a highly diagrammatic illustration of a Kaplan turbine. A rotor blade 6 is pivotally attached to a central rotor hub 1. The rotor blade 6 may be rotated by a linkage via a regulating rod. A hydraulic servomotor 2 according to the invention is mounted to drive the regulating rod and linkage of the adjustable blade 6. Kaplan turbines are propeller-type water turbines in which the rotor blades or runner blades 6 are adjustable. In other words, hydroelectric power plants with runners of the Kaplan type represent an anomaly, insofar as they are regulated twice, that is to say the operating state is influenced not only by the opening and closing of the diffuser, but also by the adjusting of the runner blades. A hydraulic servomotor is as a rule likewise used for the adjusting of the runner blades, and similar requirements occur here with regard to the torque to be applied, as in the case of the previously described servomotors for adjusting the diffuser. The described arrangement according to the invention of servomotor stages can therefore be used in a completely analogous manner for adjusting the rotor blades of a Kaplan runner.

Finally, it is also to be mentioned that the apparatus according to the invention also affords advantages with regard to the operational safety, for example when the individual servomotor stages are loaded with hydraulic liquid independently of one another. Thus, for example, a servomotor stage which acts only in a part range of the entire adjusting travel can be fed from a separate air vessel. In this way, an additional independent closing system for the hydroelectric power plant is obtained.

1. A hydraulic turbo machine, comprising:
a runner to be impinged by water;
a diffuser formed with a multiplicity of guide blades, said diffuser having a regulating ring for rotating said guide blades; and
at least one hydraulic servomotor having a multi-stage configuration with a plurality of stages, each stage having a housing and a piston, said housings of said stages being fixedly connected to one another, and said pistons of said plurality of stages interacting only in a part range of an entire adjusting range of said hydraulic servomotor.

2. The hydraulic turbo machine according to claim 1, wherein said at least one hydraulic servomotor is connected to rotate said regulating ring upon actuation.

3. The hydraulic turbo machine according to claim 1, wherein said runner is a Kaplan type rotor with adjustable runner blades, and said at least one hydraulic multiple stage servomotor is connected to move said runner blades upon actuation.

4. The hydraulic turbo machine according to claim 3, wherein, in the part range of the entire adjusting range in which said pistons of said stages interact, the interaction of mutually adjacent stages is effected by a non-positive connection of the respective piston to a rod of an adjacent said stage.

5. The hydraulic turbo machine according to claim 1, wherein, in the part range of the entire adjusting range in which said pistons of said stages interact, the interaction of mutually adjacent stages is effected by a non-positive connection of the respective piston to a tubular protrusion of the piston of an adjacent said stage.
